(19) United States
(12) Patent Application Publication
(10) Pub. No.: US 2007/0278984 A1
(43) Pub. Date: Dec. 6, 2007

(54) 2-Phase switched reluctance device and associated control topologies

(76) Inventors: Rodwan Tarek Adra, Peoria, IL (US); Michael Aaron Caruthers, Washington, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/443,280

(22) Filed: May 31, 2006

(51) Int. Cl. H02P 1/46

(52) U.S. Cl. 318/701

(57) ABSTRACT

A 2-phase switched reluctance device topology includes a switched reluctance device having first and second phase coils. Each of the first and second phase coils has a first terminal and a second terminal. The first terminal of each of the first and second phase coils is electrically coupled between two switching elements of a first pair of switching elements. The second terminal of the first phase coil is electrically coupled between two switching elements of a second pair of switching elements. The second terminal of the second phase coil is electrically coupled between two switching elements of a third pair of switching elements. Each switching element includes a first electrode, a second electrode, and a control electrode, wherein the control electrode is communicatively coupled to a switch controller that operates the switching element. Each switching element also includes a diode communicatively coupling the first electrode to the second electrode.

### TECHNICAL FIELD

The present disclosure relates generally to switched reluctance devices and, more particularly, to a 2-phase switched reluctance device and associated control topologies.

### BACKGROUND

Switched reluctance (also known as variable reluctance) machines are becoming increasingly popular in automotive and industrial applications due, in large part, to their lower cost, increased reliability, and greater power/weight ratio when compared with other conventional motor/generator types. For example, because they do not require expensive “rare-earth” magnets like their permanent-magnet counterparts and do not use brushes or split-rings that are prone to failure after prolonged or extended use like wound-rotor AC induction motors, they may be less expensive to manufacture and provide increased reliability. Furthermore, unlike AC induction machines, switched reluctance machines do not require rotor conductors, which may substantially increase the weight of the machine, the inertia of the rotor, and the difficulty in the cooling of the rotor.

Although switched reluctance machines provide certain cost and reliability advantages over other types of machines, they require separate control systems for exciting the electromagnetic field associated with the machine. These control systems may be customized based on the desired operational and/or design characteristics associated with a particular machine. For example, in many cases control systems are customized based on the number of poles and/or phase coils of the machine.

One such system is described in U.S. Pat. No. 6,054,819 (“the '819 patent”) to Pengov on Apr. 25, 2006. The system of the '819 patent describes a driving circuit that includes a plurality of switching elements and freewheeling diodes configured to provide a switching solution for operating a switched reluctance machine. The system of the '819 patent may be expandable to accommodate multiple phases by cascading an additional switch and diode with the base system, thereby enabling motor control capabilities for any multi-phase switched reluctance machine.

Although the system of the '819 patent may provide one control system solution for a multi-phase machine, it may include several disadvantages. Specifically, the configuration options for machines that employ the control system of the '819 patent may be limited and inflexible. For example, because the system is adapted for use with a particular machine design, only one wiring configuration may be supported. As a result, should one or more of the switches or diodes fail, maintenance or replacement of the control system may be required. Furthermore, because the system may not be re-configured “on the fly,” applications requiring different and/or alternative wiring schemes associated with the machine may not be supported by the system of the '819 patent. Thus, in order to provide increased system flexibility, a universal control system that provides multiple wiring solutions for switched reluctance machines may be required.

The presently disclosed 2-phase switched reluctance device and control topologies are directed toward overcoming one or more of the problems set forth above.

### SUMMARY OF THE INVENTION

In accordance with one aspect, the present disclosure is directed toward a 2-phase switched reluctance device. The device topology may include a switched reluctance device including first and second phase coils, each of the first and second phase coils including a first terminal and a second terminal. The first terminal of each of the first and second phase coils may be electrically coupled between two switching elements of a first pair of switching elements. The second terminal of the first phase coil may be electrically coupled between two switching elements of a second pair of switching elements. The second terminal of the second phase coil may be electrically coupled between two switching elements of a third pair of switching elements. Each switching element may include a first electrode, a second electrode, and a control electrode, wherein the control electrode is communicatively coupled to a switch controller that operates the switching element. Each switching element may also include a diode communicatively coupling the first electrode to the second electrode.

According to another aspect, the present disclosure is directed toward a method for operating a 2-phase switched reluctance device having first and second phase coils wherein each of the first and second phase coils may include a first terminal and a second terminal. The method may include electrically coupling the first terminal of each of the first and second phase coils between two switching elements of a first pair of switching elements. The method may also include electrically coupling the second terminal of the first phase coil between two switching elements of a second pair of switching elements. The method may further include electrically coupling the second terminal of the second phase coil between two switching elements of a third pair of switching elements. Each switching element may include a first electrode, a second electrode, and a control electrode, wherein the control electrode is communicatively coupled to a switch controller that operates the switching element. Each switching element may also include a diode communicatively coupling the first electrode to the second electrode.

In accordance with yet another aspect, the present disclosure is directed toward a machine comprising a power source and a switched reluctance device operatively coupled to the power source including first and second phase coils. Each of the first and second phase coils may include a first terminal and a second terminal. The first terminal of each of the first and second phase coils may be electrically coupled between two switching elements of a first pair of switching elements. The second terminal of the first phase coil may be electrically coupled between two switching elements of a second pair of switching elements. The second terminal of the second phase coil may be electrically coupled between two switching elements of a third pair of switching elements. Each switching element may include a first electrode, a second electrode, and a control electrode, wherein the control electrode is communicatively coupled to a switch controller that operates the switch. Each switching element may also include a diode communicatively coupling the first electrode to the second electrode.

### BRIEF DESCRIPTION OF THE DRAWINGS

FIG. 1 provides a diagrammatic illustration of an exemplary disclosed machine employing a 2-phase switched reluctance device consistent with certain disclosed embodiments;

FIG. 2 provides an exemplary illustration of a 2-phase switched reluctance machine in accordance with certain disclosed embodiments;

FIG. 3 provides an exemplary illustration of a 3-phase power converter for a switched reluctance machine, in accordance with the disclosed embodiments;

FIGS. 4A and 4B provide schematic illustrations of a first exemplary switched reluctance motor topology consistent with the disclosed embodiments;

FIG. 5 provides a table illustrating alternative switched reluctance motor topologies consistent with the exemplary embodiment illustrated in FIGS. 4A and 4B;

FIGS. 6A and 6B provide schematic illustrations of a second exemplary switched reluctance motor topology consistent with the disclosed embodiments; and

FIG. 7 provides a chart illustrating alternative switched reluctance motor topologies consistent with the exemplary embodiment illustrated in FIGS. 6A and 6B.

### DETAILED DESCRIPTION

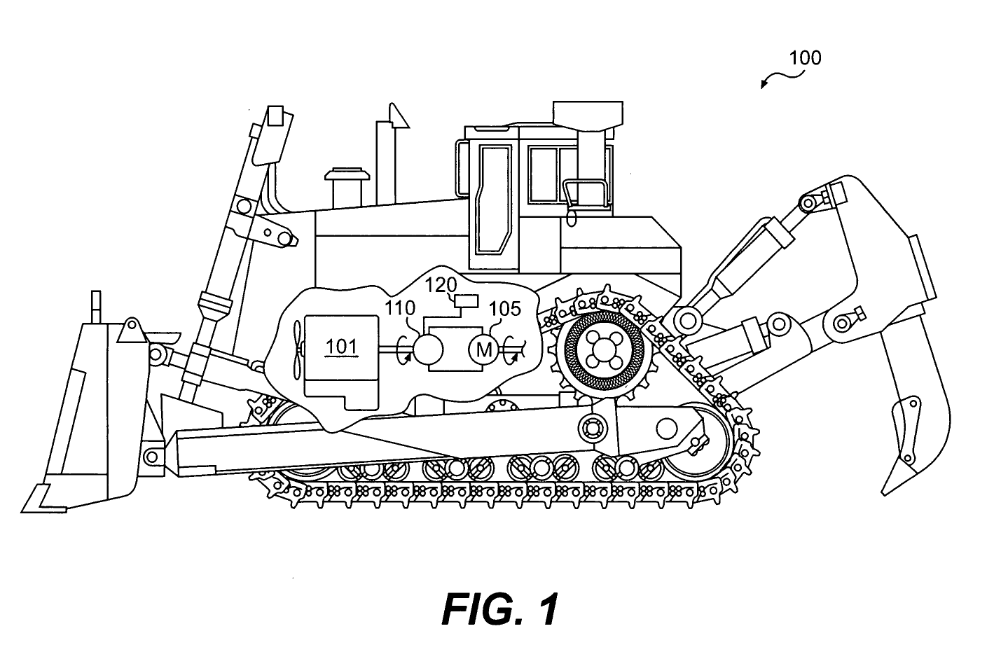

FIG. 1 provides an illustration of an exemplary machine 100, consistent with certain disclosed embodiments. Machine 100, as the term is used herein, refers to any fixed or mobile machine that performs some type of operation associated with an industry such as mining, construction, farming, transportation, manufacturing, energy exploration or any other industry. Non-limiting examples of fixed machines include an engine system operating in an off-shore plant environment (e.g., off-shore drilling platform), a stationary generator set for generating electricity, a turbine operating in a power plant environment, and any other type of fixed machine. Non-limiting examples of mobile machines include commercial and/or passenger vehicles, cranes, excavators, backhoes, haulers, dumpers, tractors, marine vessels, aircraft, mining vehicle, earth moving machines, loggers, and any other type of moveable machine. Machine 100 may be driven by a combustion engine, a turbine, or an electric motor. The types of machines listed above are exemplary only and not intended to be limiting. Furthermore, it is contemplated that although FIG. 1 is illustrated as a track-type tractor, it may include any suitable type of machine operable to perform a desired task. As illustrated in FIG. 1, machine 100 may include, among other things, a power source 101, a motor 105, a switched reluctance machine 110, and a power converter 120.

Power source 101 may include any device configured to output energy for use by machine 100. For example, power source 101 may include an internal combustion engine that operates on diesel fuel, gasoline, natural gas, or any other type of fuel. Alternatively and/or additionally, power source 101 may include any type of device configured to output mechanical and/or electrical energy such as, for example, a fuel cell, battery, turbine, alternator, transformer, or any other appropriate power output device.

Switched reluctance machine 110 may be operatively coupled to power source 101 and may be configured to convert at least a portion of the power output associated with power source 101 into electrical energy. For example, switched reluctance machine 110 may include a power converter 120 for sequentially energizing phase coils in order to produce an electromagnetic field electrical energy from. Switched reluctance machine 110 may also include a power converter configured to control the switched reluctance machine and produce electric power at various voltage and/or current levels.

Motor 105 may be operatively coupled to switched reluctance machine 110 and configured to provide mechanical force for performing a task associated with machine 100. Motor 105 may receive electrical energy from switched reluctance machine 110 to produce torque output for performing work. For example, motor 105 may be coupled to a transmission (not shown) for providing output torque to a shaft to move one or more traction devices to propel machine 100. Although motor 105 may be described as a drive for one or more traction devices (not shown), it is contemplated that motor 105 may be used in any application of machine 100 that may require mechanical energy to operate. Motor 105 may include any type of motor such as, for example, a switched reluctance motor (similar to switched reluctance device 110), an AC induction motor, a synchronous motor, a brushless DC motor, or any other suitable type of motor.

It is contemplated that, in certain cases, switched reluctance machine 110 may be configured to operate as a motor for receiving electrical energy and converting a portion of the electrical energy to mechanical energy for use by one or more components, such as power source 101, associated with machine 100. For example, in situations where switched reluctance machine 110 is not providing electrical power, it may be operated as a motor for supplying mechanical power for machine 100. This power may be provided to power source 101 for operating parasitic power source loads and/or reducing fuel consumption. According to one embodiment, switched reluctance device 110 may include any type of motor or generator that is configured to unidirectional power flow.

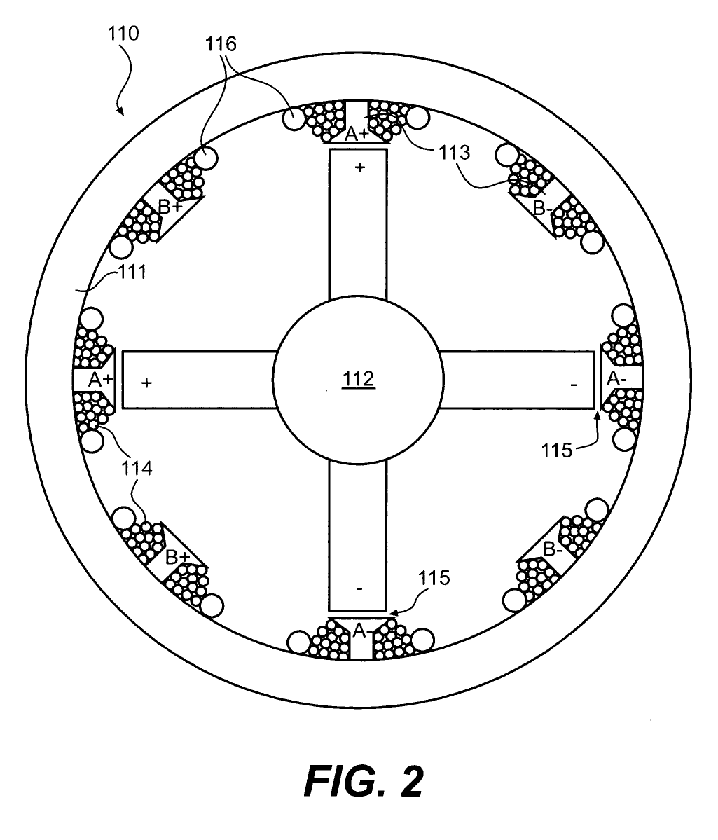

As illustrated in FIG. 2, switched reluctance machine 110 may include a stator 111 electromagnetically coupled to an actuator 112 and separated by an air gap 115 over which an electromagnetic field is induced. Switched reluctance machine 110 may also include phase coils 114 substantially wound around poles 113 for supplying electrical energy to induce an electromagnetic field between stator 111 and actuator 112. It is also contemplated that switched reluctance machine 110 may include any appropriate type of motor for providing mechanical energy output, such as a linear motor, a stepper motor, or any other type of motor that is operated with uni-directional current flow within the coils of the motor. Alternatively and/or additionally, switched reluctance machine 110 may include an electric generator for providing a electric power output.

Stator 111 may include a high magnetic permeability metallic core, such as, for example, iron, cobalt, nickel, or any other high permeability metal or alloy thereof, configured to promote a magnetic flux proportional to a magnetizing current. For example, stator 111 may include an iron core of particular size, shape, and dimension so as to maximize the magnetic flux density given the size and configuration of actuator 112. Although stator 111 is illustrated as a substantially circular stator for use with a rotor, it is contemplated that stator 111 may include a linear stator for use with a linear motive bar, as in, for example, a linear motor or as a platter configuration as used in an axial flux designed motor.

Actuator 112 may include a metallic core operatively coupled to stator 111 and configured to move relative to stator 111 in the presence of a magnetic field. For example, as illustrated in FIG. 2, actuator 112 may include a substantially round core disposed within stator 111 and configured to rotate within stator 111 in the presence of a generated electromagnetic field. Although actuator 112 is illustrated as a rotor in one exemplary embodiment, actuator 112 may include a metallic beam configured to move linearly with respect to stator 111, as in a linear motor. Actuator 112 may include high magnetic permeability metallic structure such as, for example, iron, cobalt, nickel, or any other such type of appropriate material.

Poles 113 may include salient metallic structures that may protrude from stator 111 to provide a highly concentrated magnetic flux density to provide greater electromagnetic interaction with actuator 112. Poles 113 may be constructed of a high relative permeability metal such as, for example, iron, cobalt, nickel, or any other such material. The number of poles 113 may be selected based on the desired speed and torque relationship depending upon the prospective use of the motor during the design stages. Although switched reluctance machine 110 is illustrated as an eight pole machine, it is contemplated that more or less poles may be provided depending on the desired performance of switched reluctance machine 110.

Phase coils 114 may include one or more wires associated with poles 113 and configured to induce a magnetic flux within poles 113. Phase coils 114 may be constructed of any material that has a substantially high conductivity such as copper, iron, steel, aluminum, or any other suitable material for conducting current. Further electric conductors may be substantially wound around poles 113 to maximize the current-induced magnetic flux within poles 113.

Phase coils 114 may be arranged in phases such that, when phase coils 114 are energized, the magnetic flux generated within poles 113 cooperate to provide maximum rotational force on actuator 112. For example, in one embodiment, phases may be arranged such that phase coils 114 associated with pairs of poles 113 that are diametrically opposed induce a uniform, symmetric magnetic field to move actuator 112. Although switched reluctance machine 110 is illustrated as a symmetric motor, it is contemplated that asymmetric configurations may be realized with phase coils 114 arranged to provide a uniform magnetic field for moving actuator 112.

According to one embodiment, switched reluctance machine 110 may include one or more internal cooling devices 116 for extracting heat associated with switched reluctance machine 110. For example, internal cooling devices 116 may include thermally conductive elements, such as metallic materials that, when placed in proximity to a heat source, may facilitate dissipation of heat from the heat source. Alternatively and/or additionally, internal cooling devices 116 may include one or more cooling circuits for circulating a cooling medium, such as, for example, ethylene glycol, propylene glycol, water, air, gel coolants, or any other suitable cooling medium. It is contemplated that the internal cooling devices 116 may be coupled to an external heat transfer device (not shown), such as a radiator, fan, or other device for dissipating the heat collected by internal cooling devices 116. According to one embodiment, internal cooling devices 116 may be coupled to a coolant reservoir (not shown) for storing a cooling medium associated with internal cooling devices 116. It is contemplated that internal cooling devices 116 may include any cooling feature that may be adapted to cool switched reluctance machine 110.

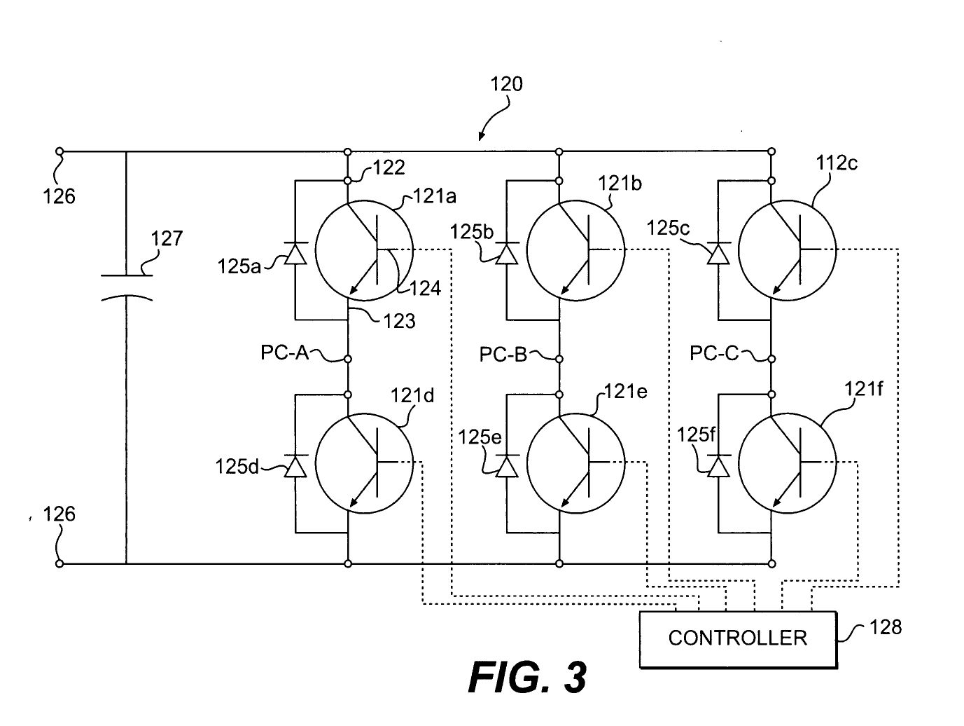

As illustrated in FIG. 3, power converter 120 may include one or more components configured to energize multiple phases of an electric machine using a single power supply device. For example, power converter 120 may be electrically coupled to switched reluctance machine 110 and configured to sequentially provide electric current for energizing phase coils 114. Power converter 120 may include one or more switching devices 121a-f, one or more switching diodes 125a-f, voltage input terminals 126 for receiving a input power, and a shunt capacitor 127 reducing AC and other high-frequency signals associated with the input power.

Switching devices 121a-f may each include one or more electrical devices configured to provide one or more current flow paths associated with power converter 120. Each of switching devices 121a-f may include two operational states: an “on” state whereby the switching device permits a flow of current through the device, and an “off” state whereby the switching device prevents the flow of current through the device. Switching devices 121a-f may each include a solid-state semiconductor switching device such as, for example, an insulated gate bipolar transistor (IGBT) switch, a CMOS switching element, a MOSFET switch, or any other suitable type of switching element. According to an exemplary embodiment, switching devices may include insulated gate bipolar transistors due to their high current handling capability. Furthermore, although switching elements 121a-f are illustrated as npn devices, it is contemplated that switching devices may include pnp devices, n-channel devices, p-channel devices or any other suitable type of semiconductor switching element.

Switching devices 121a-f may each include, among other things, a first electrode 122, a second electrode 123, and a control electrode 124. Switching devices 121a-f may each be actuated by the application of control signals to control electrode 124 by a switch controller 128. For instance, switch controller 128 may provide a signal corresponding to an “on” state to control electrode 124, thereby inducing a conduction channel in the switching device and permitting current flow through the device. Similarly, switch controller 128 may provide a signal corresponding to an “off” state to control electrode 124, thereby removing off the conduction channel and preventing the flow of current through the device.

Diodes 125a-f may be operatively coupled to each of switching devices 121a-f to provide a reverse flow path of current between first electrode 122 and second electrode 123. For example, diodes 125a-f may each be coupled between the first electrode 122 and the second electrode 123 associated with its respective switching devices 121a-f. By providing a reverse flow path of current, diodes 125a-f may protect the corresponding switching devices 125a-f from potential damage from the buildup of high reverse voltage potentials. In addition, diodes 125a-f may provide a conduction path for energy flow back to the DC source when switched reluctance machine 110 is generating power. According to one embodiment, each of diodes 125a-f may be included with a corresponding switching devices 121a-f as part of a single integrated switching element. Alternatively, switching devices 121a-f and diodes 125a-f may be separate, standalone components.

Power converter 120 embodies a standard 3-phase power converter for use with many types of 3-phase industrial machine. As illustrated in FIG. 3, switching devices 121a-f are arranged as three pairs of series-connected switching devices, with each pair arranged in parallel with each other pair. Each pair comprises a first switching element (e.g., 121a, 121b, and 121c, respectively) and a second switching element (e.g., 121d, 121e, and 121f, respectively). The first electrode 122 of each of the first switching elements may be electrically coupled to a first DC voltage potential. The second electrode 123 of each of the first switching elements may be electrically coupled to the first electrode 122 of the respective second switching elements forming a contact node PC-A, PC-B, and PC-C, respectively, providing three connection points for the field winding in a typical 3-phase machine wiring configuration. The second electrode of each of the second switching elements may be coupled to a second DC voltage potential. According to one embodiment, the first DC voltage potential may be greater than the second DC voltage potential.

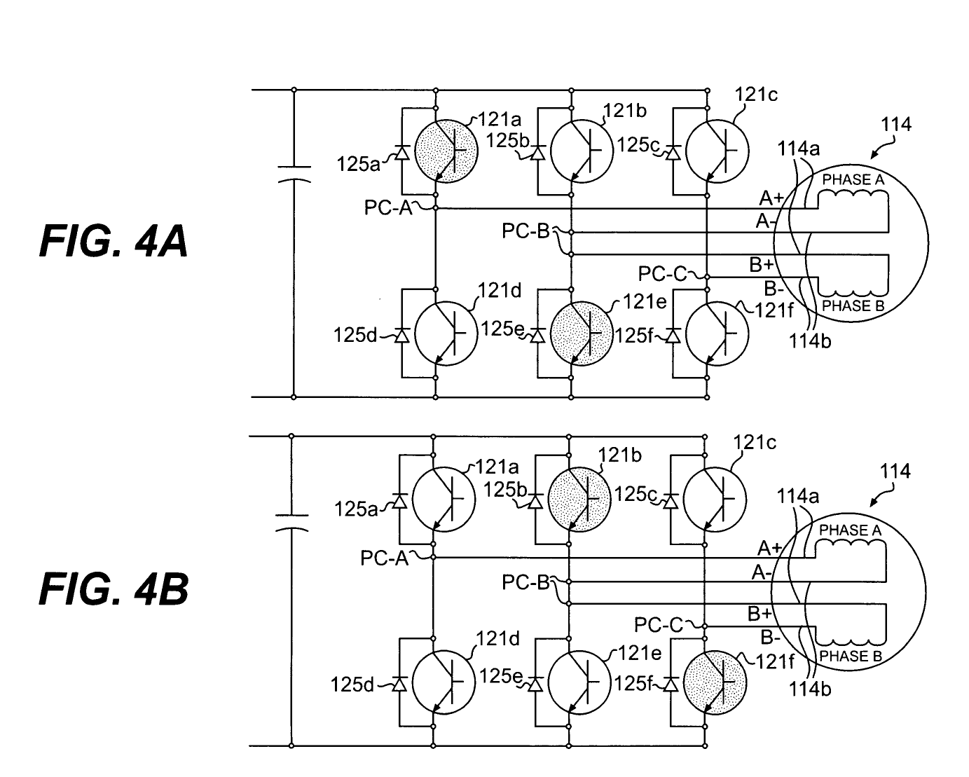

FIGS. 4A and 4B illustrate one exemplary switched reluctance machine topology for operating a 2-phase switched reluctance machine, such as switched reluctance machine 110, using a 3-phase universal power converter, such as power converter 120. As illustrated in FIGS. 4A and 4B, phase coils 114 may include first and second phases A and B, respectively, with each phase coil including positive and negative terminals. In this configuration, the positive terminal of phase coil A may be electrically coupled to contact node PC-A, while the negative terminal of phase coil B may be electrically coupled to contact node PC-C. The negative terminal of phase coil A and the positive terminal of phase coil B may each be electrically coupled to contact node PC-B.

In order to maximize efficiency, first and second phase coils associated with switched reluctance machine 110 must be operated alternately (i.e., phase coil A may not conduct current while phase coil B is conducting current). Thus, to operate switched reluctance machine 110, each phase is individually excited. As illustrated in FIG. 4A, for example, phase A is excited by placing switching devices 121a and 121e in the “on” state, enabling current flow through switching device 121a, through phase coil A, and through switching device 121e. This current flow induces a electromagnetic field around the poles associated with phase coils A, which attracts the poles of actuator 112. Once the poles of the actuator 112 are nearly in line with the poles of the stator (i.e., maximum torque position), switching devices 121a and 121e are placed in the “off” state. Because phase coil A is essentially a large inductor, a current flow path for discharging phase coil A may be provided to quickly eliminate any residual current that may be stored in the coils, thereby limiting the resistance associated with actuator 112 due to any electromagnetic field that may be produced by the residual current. This current flow path may be provided by diodes 125b and 125d. It is contemplated that the switched reluctance machine 110 may be configured to generate output power by turning on switching devices 121a and 121e slightly before alignment and, subsequently turning them off slightly after alignment. After switching devices 121a and 121e have been turned off, switched reluctance machine 110 may continue to generate current through diodes 125d and 125b until poles are aligned.

As illustrated in FIG. 4B, once switching devices 121a and 121e have been placed in the “off” state, switching devices 121b and 121f may be placed in the “on” state. As a result, switching devices 121b and 121f provide a current flow path through phase coil B, which energizes the stator poles associated with phase coil B. This current flow induces an electromagnetic field around the stator poles, which attracts the poles of actuator 112, producing torque and facilitating angular rotation. When the poles of actuator 112 become nearly aligned with the poles of the stator, switching devices 121b and 121f are placed in the “off” state, the residual current in phase coil B discharges through diodes 125e and 125c, discharging the electromagnetic field associated with the stator poles of phase coil B.

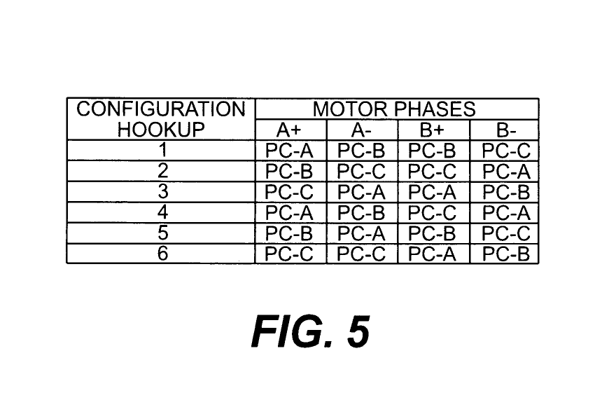

According to the embodiments illustrated in FIGS. 4A and 4B, only four switching devices (121a, 121b, 121e and 121f) are used and only four diodes (125b, 125c, 125d, and 125e) are used. As a result, those of ordinary skill will realize that additional wiring configurations may be implemented that use different combinations of switching elements and diodes. Other permutations and combinations of wiring topologies consistent with the embodiments illustrated in FIGS. 4A and 4B are illustrated in the chart of FIG. 5. As illustrated in FIG. 5, multiple wiring topologies may be realized using 3-phase power converter 120 to energize 2-phase switched reluctance machine 110, that utilize four switching devices and four diodes.

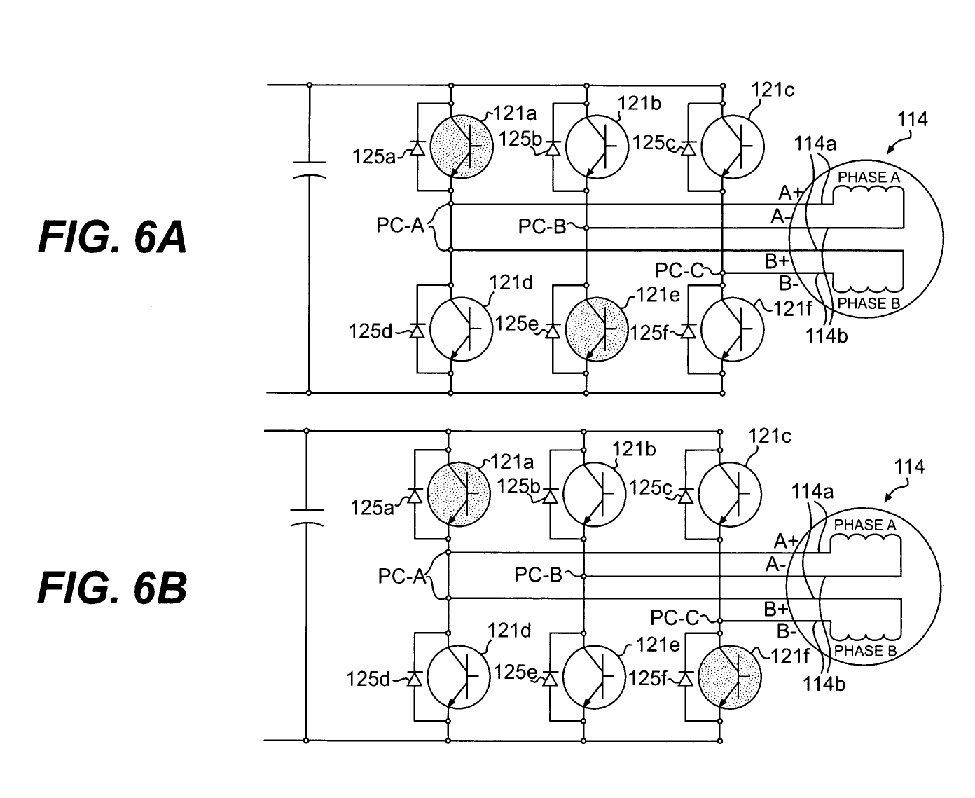

FIGS. 6A and 6B illustrate an exemplary disclosed configuration in which only three switching devices and three diodes are used. According to this embodiment, positive terminals of phase coil A and phase coil B may be electrically coupled to PC-A, while the negative terminals of phase coils A and B may be coupled to PC-B and PC-C, respectively.

According to this embodiment, switching devices 121a and 121e may be placed in the “on” state to energize phase coil A. Once switching devices 121a and 121e are placed in the “off” state, the residual current may be discharged through diodes 125d and 125b. Similarly, switching devices 121a and 121f may be placed in the “on” state allowing energizing current to flow through phase coil B. When switching devices 121a and 121f are placed in the “off” state, the residual current may be discharged through diodes 125d and 125c.

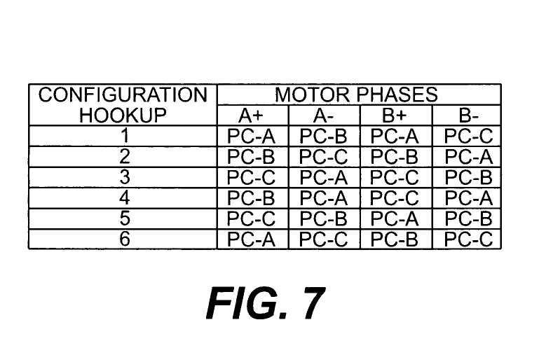

FIGS. 6A and 6B illustrate only one configuration where switched reluctance machine 110 may be electrically coupled to power converter 120 such that only three switching devices and three diodes may be required to operate switched reluctance machine 110. It is contemplated that additional switch topologies may be provided that use three switching devices and three diodes of power converter, and that those skilled in the art will recognize that additional wiring topologies may be implemented without departing from the scope of the present disclosure. For example, FIG. 7 provides a table illustrating alternative wiring topologies using 3-phase power converter 120 to energize 2-phase switched reluctance machine utilizing only three switching devices and three diodes.

### INDUSTRIAL APPLICABILITY

Although the configurations and topologies associated with the disclosed 2-phase switched reluctance machine are illustrated and described in connection with the motor operation of the machine, it is contemplated that these configurations and topologies may also be applied to the operation of the machine as a generator. Indeed, the only difference between the motor and generator operation of 2-phase switched reluctance machine 110 lies in the timing and sequencing of the operations of switching devices 121a-f.

The presently disclosed 2-phase switched reluctance device and its associated topologies may have several advantages. First, the disclosed machine topology may significantly reduce the time associated with power converter repair and/or replacement, in the event of a failure. For example, the 2-phase switched reluctance machine topologies provide multiple wiring configuration schemes. As a result, should one or more of the switching devices and/or diodes fail or otherwise become inoperable, the motor topology may be easily re-configured by simply re-wiring the phase coils to the power converter. This may substantially reduce the time and cost associated with replacement of the power converter.

Additionally, the disclosed switched reluctance machine topology may provide increased flexibility. For example, power converter 120 associated with the 2-phase switched reluctance machine topology may be universally used with any 2- or 3-phase industrial machine, reducing the need for customized or specialized power converter design. Furthermore, because power converter 120 may be used in almost any 2- or 3-phase commercial or industrial machine, the costs associated with stocking and maintaining associated with repair and/or replacement parts for separate power converters may be significantly reduced.

It will be apparent to those skilled in the art that various modifications and variations can be made to the disclosed 2-phase switched reluctance device and associated control topologies. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A 2-phase switched reluctance device, comprising:
a switched reluctance device including first and second phase coils, each of the first and second phase coils including a first terminal and a second terminal;
wherein the first terminal of each of the first and second phase coils is electrically coupled between two switching elements of a first pair of switching elements;
the second terminal of the first phase coil is electrically coupled between two switching elements of a second pair of switching elements; and
the second terminal of the second phase coil is electrically coupled between two switching elements of a third pair of switching elements; and
wherein each switching element includes:
a first electrode, a second electrode, and a control electrode, wherein the control electrode is communicatively coupled to a switch controller that operates the switching element; and
a diode communicatively coupling the first electrode to the second electrode.

2. The device of claim 1, wherein the first terminal of each of the first and second phase coils includes a positive lead and the second terminal of each of the first and second phase coils includes a negative lead.

3. The device of claim 1, wherein the first terminal of the first phase coil differs in polarity from the first terminal of the second phase coil and the second terminal of the first phase coil differs in polarity from the second terminal of the second phase coil.

4. The device of claim 1, wherein each pair of the three pairs of switching elements includes a first and second switching element arranged in a series configuration, wherein:
the first electrode of the first switching element is electrically coupled to a first DC potential;
the second electrode of the first switching element is electrically coupled to a first electrode of the second switching element; and
the second electrode of the second switching element is electrically coupled to a second DC potential.

5. The device of claim 4, wherein each pair of the three pairs of switching elements are arranged in a parallel configuration.

6. The device of claim 4, wherein the first DC potential is greater than the second DC potential.

7. The device of claim 1, wherein each of the switching elements further include a solid state switching device.

8. The device of claim 7, wherein the solid state switching device includes one or more of a insulated gate bipolar transistor, a bipolar junction transistor, or a MOS transistor.

9. The device of claim 1, wherein the switched reluctance device includes one or more cooling features adapted to extract heat from the first and second phase coils;

10. The device of claim 9, wherein the one or more cooling features includes a liquid cooling system.

11. A method for operating a 2-phase switched reluctance device having first and second phase coils, each of the first and second phase coils including a first terminal and a second terminal, wherein the method comprises:
electrically coupling the first terminal of each of the first and second phase coils between two switching elements of a first pair of switching elements;
electrically coupling the second terminal of the first phase coil between two switching elements of a second pair of switching elements; and
electrically coupling the second terminal of the second phase coil between two switching elements of a third pair of switching elements;
wherein each switching element includes:
a first electrode, a second electrode, and a control electrode, wherein the control electrode is communicatively coupled to a switch controller that operates the switching element; and
a diode communicatively coupling the first electrode to the second electrode.

12. The method of claim 11, further including selectively operating one or more switching elements to alternate a flow of current through the first and second phase coils.

13. The method of claim 12, wherein selectively operating the one or more switching elements further includes determining, based on a desired torque output of the switched reluctance device, a switch interval and switch sequence associated with the one or more switching elements.

14. The method of claim 12, wherein selectively operating the one or more switching elements further includes determining, based on a desired angular velocity of a rotor associated with the switched reluctance device, a switch interval and switch sequence associated with the one or more switching elements.

15. The method of claim 12, wherein selectively operating the one or more switching elements further includes determining, based on a desired mode of operation of the switched reluctance device, a switch interval and switch sequence associated with associated with the one or more switching elements.

16. A machine comprising:
a power source;
a switched reluctance device operatively coupled to the power source including first and second phase coils, each of the first and second phase coils including a first terminal and a second terminal;
wherein the first terminal of each of the first and second phase coils is electrically coupled between two switching elements of a first pair of switching elements;
the second terminal of the first phase coil is electrically coupled between two switching elements of a second pair of switching elements; and
the second terminal of the second phase coil is electrically coupled between two switching elements of a third pair of switching elements; and
wherein each switching element includes:
a first electrode, a second electrode, and a control electrode, wherein the control electrode is communicatively coupled to a switch controller that operates the switching element; and
a diode communicatively coupling the first electrode to the second electrode.

17. The machine of claim 16, wherein the first terminal of each of the first and second phase coils includes a positive lead and the second terminal of each of the first and second phase coils includes a negative lead.

18. The machine of claim 16, wherein the first terminal of the first phase coil differs in polarity from the first terminal of the second phase coil and the second terminal of the first phase coil differs in polarity from the second terminal of the second phase coil.

19. The machine of claim 16, wherein each pair of the three pairs of switching elements includes a first and second switching element arranged in a series configuration, wherein
the first electrode of the first switching element is electrically coupled to a first DC potential;
the second electrode of the first switching element is electrically coupled to a first electrode of the second switching element; and
the second electrode of the second switching element is electrically coupled to a second DC potential.

20. The machine of claim 16, wherein each pair of the three pairs of switching elements are arranged in a parallel configuration.
